(19) United States
(12) Patent Application Publication
(10) Pub. No.: US 2025/0383784 A1
(43) Pub. Date: Dec. 18, 2025

(54) REDUCING READ DISTURBANCE OVERESTIMATION

(71) Applicant: Micron Technology, Inc., Boise, ID (US)

(72) Inventors: Francesco Falanga, Quarto (NA) (IT); Giuseppe D'Eliseo, Caserta (IT); Francesco Basso, Portici (IT); Alberto Sassara, Napoli (IT); Giuseppe Ferrari, Napoli (IT); Pierpaolo Piccirillo, Sant’Anastasia (IT); Dionisio Minopoli, Frattamaggiore (IT); Ting Luo, Santa Clara, CA (US)

(21) Appl. No.: 19/219,813

(22) Filed: May 27, 2025

Related U.S. Application Data
(60) Provisional application No. 63/659,467, filed on Jun. 13, 2024.

(51) Int. Cl. G06F 3/06

(52) U.S. Cl. CPC G06F 3/0616; G06F 3/0659; G06F 3/0673

(57) ABSTRACT

Methods, systems, and devices for reducing read disturbance overestimation are described. A memory system may maintain a bitmap associated with a virtual block, where the virtual block may be associated with first blocks across multiple dies and each bit of the bitmap may correspond to a respective first block of each die. The memory system may perform a first read operation at the first block of a first die and, accordingly, may set a first bit of the bitmap to a first value. The memory system may determine whether to adjust a read counter associated with the virtual block based on values within the bitmap. For example, the memory system may adjust the read counter based on determining that each bit of the bitmap is set to the first value or based on performing a second read operation on the first block of the first die.

### CROSS REFERENCE

The present application for patent claims priority to U.S. Patent Application No. 63/659,467 by Falanga et al., entitled “REDUCING READ DISTURBANCE OVERESTIMATION,” filed Jun. 13, 2024, which is assigned to the assignee hereof, and which is expressly incorporated by reference in its entirety herein.

### TECHNICAL FIELD

The following relates to one or more systems for memory, including reducing read disturbance overestimation.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports reducing read disturbance overestimation in accordance with examples as disclosed herein.

FIG. 2A shows an example of a system that supports reducing read disturbance overestimation in accordance with examples as disclosed herein.

FIG. 2B shows an example of a system that supports reducing read disturbance overestimation in accordance with examples as disclosed herein.

FIG. 3 shows an example of a process flow that supports reducing read disturbance overestimation in accordance with examples as disclosed herein.

FIG. 4 shows a block diagram of a memory system that supports reducing read disturbance overestimation in accordance with examples as disclosed herein.

FIGS. 5 and 6 show flowcharts illustrating a method or methods that support reducing read disturbance overestimation in accordance with examples as disclosed herein.

### DETAILED DESCRIPTION

Some memory systems may maintain a record to track read operations, such as a respective read counter to count read operations, at each virtual block of the memory system. For example, each virtual block of the memory system may be associated with a set of memory dies. Accordingly, if a read operation (e.g., a read disturbance) occurs at one of the memory dies of the set associated with a first virtual block, the memory system may increment the read counter associated with the first virtual block. In response to the read counter associated with the virtual block reaching a threshold, the memory system may trigger performance of one or more refresh operations at the set of memory dies associated with the first virtual block. In such examples, if multiple read operations occur at the set of memory dies associated with the first virtual block, the memory system may increment the read counter multiple times (e.g., increment by one for each read operation), which may increase the likelihood of the read counter reaching the threshold. As such, the memory system may experience an excess of refresh operations at the set of memory dies due to an overestimation of the read operations (e.g., read disturbances) tracked by the read counters, which may cause unnecessary blocks of memory cells (e.g., NAND blocks) to wear out, an increase in latency and a reduction in performance at the memory system. Thus, solutions which allow a memory system to reduce read disturbance overestimation may be desirable.

According to the techniques described herein, the memory system may maintain information, such as a bitmap, for each virtual block of the memory system. For example, the memory system may maintain a first bitmap associated with the first virtual block, where each bit of the bitmap may correspond to a respective memory die of the set of memory dies associated with the first virtual block. In such examples, the memory system may perform a first read operation at a first memory die of the set of memory dies, where, based on (e.g., in response to) the first read operation, the memory system may set a first bit of the bitmap to a first value (e.g., ‘1’). Accordingly, the memory system may determine whether to adjust (e.g., increment) the read counter associated with the first virtual block according to (e.g., based on) respective values of each bit of the bitmap. For example, the memory system may adjust (e.g., increment) the read counter based on determining that each bit of the bitmap is set to the first value (e.g., ‘1’). Additionally, or alternatively, the memory system may adjust (e.g., increment) the read counter based on (e.g., in response to) performing a second read operation on the first memory die, where the bit of the bitmap corresponding to the first memory die has already been set to the first value (e.g., the second read operation is subsequent to the first read operation).

In this way, the memory system may refrain from adjusting (e.g., incrementing) the read counter associated with the first virtual block until a respective read operation has been performed at each memory die associated with the first virtual block, until consecutive read operations are performed at a first memory die associated with the virtual block, or both. By performing such operations, the memory system may manage the read counter associated with the first virtual block, thereby decreasing the quantity of refresh operations performed at the set of memory dies, resulting in a reduction in excess processing, wear out at one or more blocks of memory cells (e.g., NAND blocks), decreased latency, and increased performance of the memory system, among other advantages.

In addition to applicability in memory systems as described herein, techniques for reducing read disturbance overestimation may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by decreasing read access overestimates, which may reduce excess processing and decrease latency, among other benefits.

Features of the disclosure are illustrated and described in the context of systems, devices, and circuits. Features of the disclosure are further illustrated and described in the context of systems, process flows, and flowcharts.

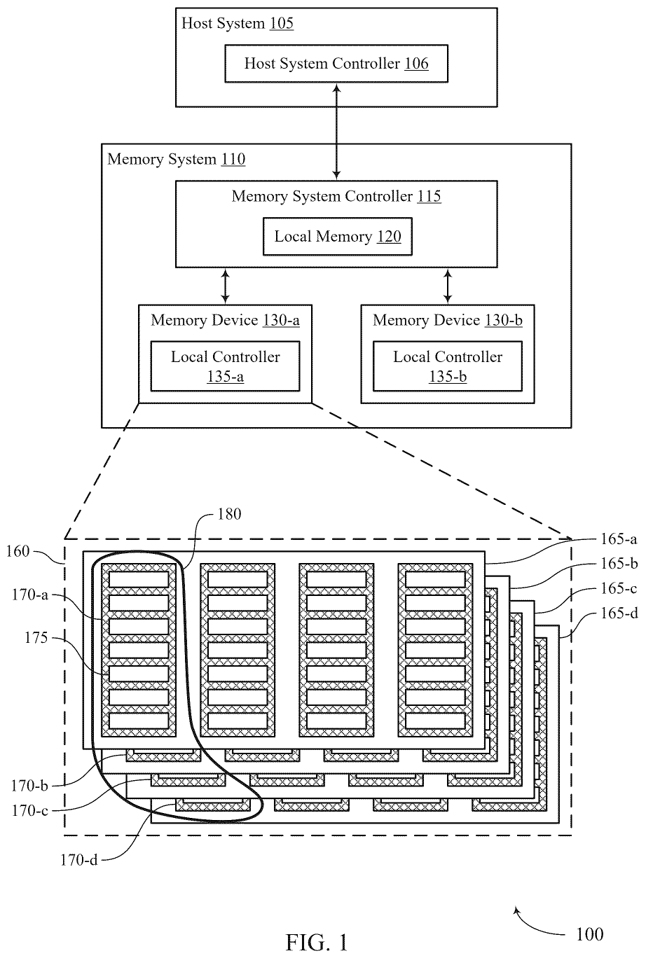

FIG. 1 shows an example of a system 100 that supports reducing read disturbance overestimation in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some systems, due to resource limitations and data management architecture constraints, one or more read counters (e.g., a read counter table (RCT)) may be virtual block based. For example, the memory system 110 may maintain, in the local memory 120 of the memory system controller 115, a respective read counter for each virtual block 180. Accordingly, if a read access occurs at one of the dies 160 associated with the virtual block 180, the memory system 110 may increment the read counter associated with the virtual block 180. In response to the read counter satisfying (e.g., reaching or equaling) a threshold, the memory system 110 may trigger a refresh operation (e.g., read disturbance management) at the dies 160 associated with the virtual block 180. In such examples, multiple read accesses may occur across different dies 160 within the virtual block 180, which may result in the memory system 110 incrementing the read counter multiple times (e.g., one for each read access), leading to an overestimation of read accesses for the virtual block 180. However, such overestimation of read access at the virtual block 180 may lead to excess refresh operations at the dies 160 associated with the virtual block 180 (e.g., lead to read disturbance refresh process overkill), which may increase write amplification worsening, latency, performance worsening, or a combination thereof.

According to the techniques described herein, the memory system 110 may maintain a bitmap for each virtual block 180 of the memory system 110. For example, the memory system 110 may maintain a first bitmap associated with the first virtual block 180, where each bit of the bitmap may correspond to a respective die 160 (or a respective set of blocks 170 of the dies 160) of the set of dies 160 associated with the first virtual block 180. In such examples, the memory system 110 may perform a first read operation at a first die 160 of the set of dies 160, where, in response to the first read operation, the memory system 110 may set a first bit of the bitmap to a first value (e.g., ‘1’). Accordingly, the memory system 110 may determine whether to increment the read counter associated with the first virtual block 180 according to (e.g., based on) respective values of each bit of the bitmap. For example, the memory system 110 may increment the read counter based on determining that each bit of the bitmap is set to the first value (e.g., ‘1’). Additionally, or alternatively, the memory system 110 may increment the read counter in response to (e.g., based on) performing a second read operation on the first die 160, where the bit of the bitmap corresponding to the first die 160 has already been set to the first value (e.g., the second read operation is subsequent to the first read operation).

In this way, the memory system 110 may refrain from incrementing the read counter associated with the first virtual block 180 until a respective read operation has been performed at each die 160 associated with the first virtual block 180, until consecutive read operations are performed at a first die 160 associated with the virtual block 180, or both. By performing such operations, the memory system 110 may manage the read counter associated with the first virtual block 180, thereby decreasing the quantity of refresh operations performed at the set of dies 160, resulting in a reduction in excess processing, decreased latency, and increased performance of the memory system 110.

Further, in some examples, the memory devices 130 (or the memory system 110) may maintain a respective bitmap for each die 160 at the memory devices 130, where each bit of the bitmap may correspond to a respective plane 165. In such examples, the memory devices 130 may also maintain a respective read counter for each die 160 at each memory device 130. For example, the memory device 130-a may maintain a bitmap, in volatile memory of the local controller 135-a, for the die 160, where each bit of the bitmap may correspond to one of the planes 165. Accordingly, the memory device 130-a may perform a first read operation at the plane 165-a (e.g., at a page 175 of the plane 165-a), where, in response to performing the first read operation at the plane 165-a, the memory device 130-a may set a first bit of the bitmap to a first value (e.g., ‘1’).

Accordingly, the memory device 130-a may determine whether to increment a read counter associated with the die 160 based on respective values each bit of the bitmap. For example, the memory device 130-a may increment the read counter based on determining that each bit of the bitmap is set to the first value. Additionally, or alternatively, the memory device 130-a may increment the read counter in response to (e.g., based on) performing a second read operation on plane 165-a, where the bit of the bitmap corresponding to the plane 165-a has already been set to the first value (e.g., the second read operation is subsequent to the first read operation). In this way, the memory device 130-a may refrain from incrementing the read counter associated with the die 160 until a respective read operation has been performed at each plane 165 associated with the die 160, until consecutive read operations are performed at the plane 165-a, or both.

The system 100 may include any quantity of non-transitory computer readable media that support reducing read disturbance overestimation. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

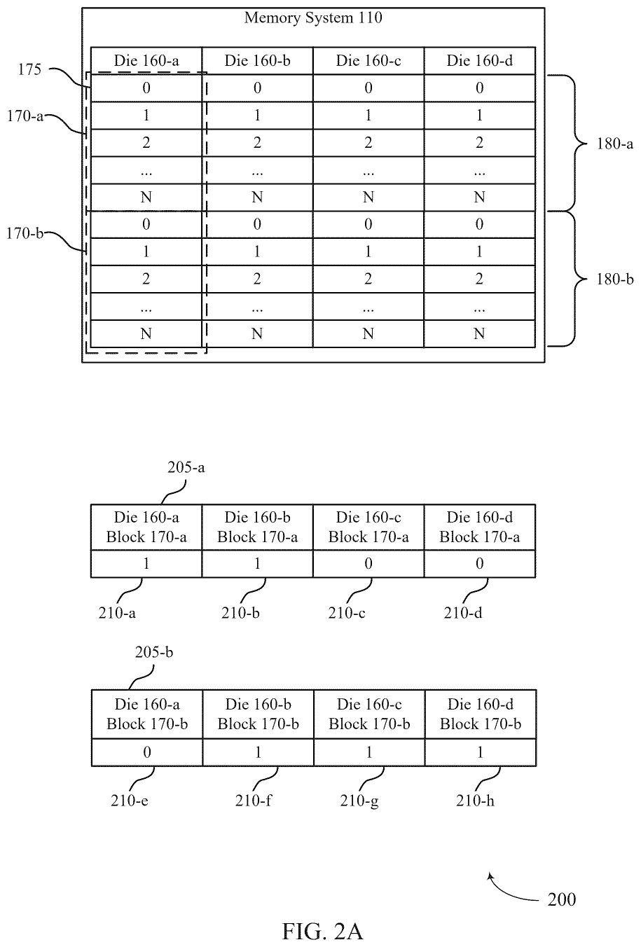

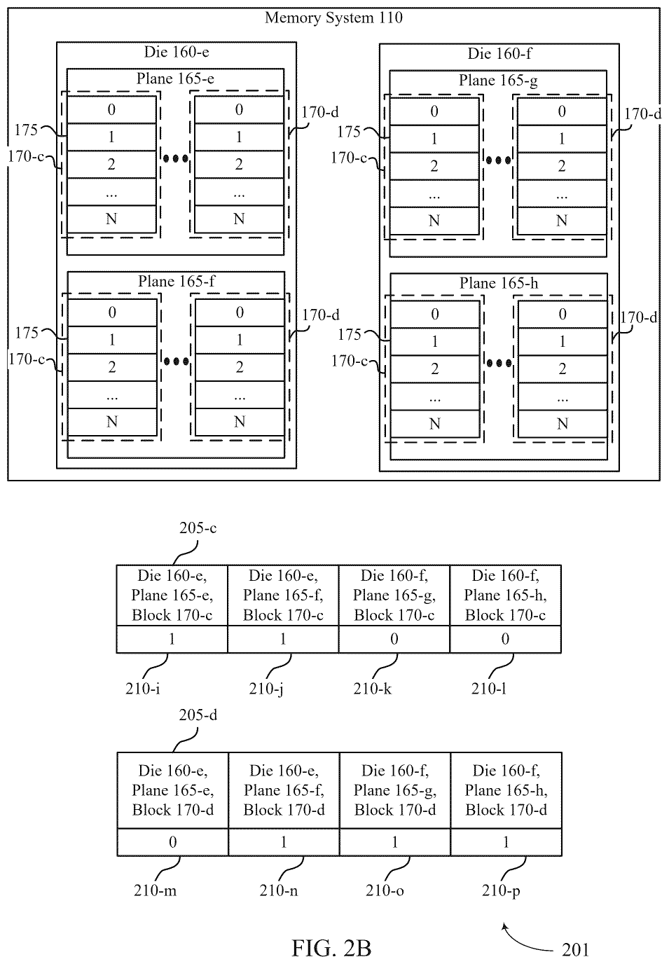

FIG. 2A shows an example of a system 200 that supports reducing read disturbance overestimation in accordance with examples as disclosed herein. Aspects of the system 200 may implement, or be implemented by, aspects of the system 100. For example, the memory system 110 may include one or more dies 160, such as dies 160-a, 160-b, 160-c, and 160-d, which may be examples of the dies 160 described herein with reference to FIG. 1. Further, each die 160 may include a set of N pages 175, where the set of N pages 175 may be included in a block 170. In the following description, some operations may be performed by a memory system controller 115 of the memory system 110, however, it should be understood that one or more components of the memory system 110 alone or in any combination may perform such operations. For example, a local controller 135 of a memory device 130 may perform the described operations.

As described herein, the memory system 110 may include a set of virtual blocks 180, where each virtual block 180 (e.g., which may be referred to as a super block in some examples) may be associated with a set of blocks 170 within the dies 160. For example, a virtual block 180-a may be associated with a first set of blocks 170 associated with a same physical block index (e.g., block index x) taken from each of the dies 160-a, 160-b, 160-c, and 160-d. Similarly, a virtual block 180-b may be associated with a second set of blocks 170 of each of the dies 160-a, 160-b, 160-c, and 160-d associated with a same physical block index (e.g., block index y).

As an illustrative example, the dies 160-a, 160-b, 160-c, and 160-d may include a block 170-a including a set of N pages 175, where the block 170-a of each die 160 may have a first block index within the respective dies 160. Similarly, the dies 160-a, 160-b, 160-c, and 160-d may include a block 170-b including a set of N pages 175, where the block 170-b of the dies 160-a, 160-b, 160-c, and 160-d may have a second block index within the respective dies 160. Accordingly, the virtual block 180-a may include the blocks 170-a across each of the dies 160, while the virtual block 180-b may include the blocks 170-b across each of the dies 160.

According to the techniques described herein, the memory system 110 may maintain one or more respective bitmaps 205 for each virtual block 180, where each bit 210 of the respective bitmaps 205 may correspond to a respective block 170 within each die 160. In such examples, the memory system 110 may utilize each bit 210 of the bitmaps 205 to track read operations (e.g., read accesses) occurring on corresponding blocks 170 of the dies 160 within the associated virtual block 180. For example, the memory system 110 may maintain at least one bitmap 205-a for the virtual block 180-a, where the bitmap 205-a may include a bit 210-a corresponding to the block 170-a of the die 160-a, a bit 210-b corresponding to the block 170-a of die 160-b, a bit 210-c corresponding to the block 170-a of the die 160-c, and a bit 210-d corresponding to the block 170-a of the die 160-d. As such, the memory system 110 may utilize the bit 210-a to track read operations performed at the block 170-a of the die 160-a, while the memory system 110 may utilize the bit 210-b to track read operations at block 170-a of the die 160-b. Similarly, the memory system 110 may maintain at least one bitmap 205-b for the virtual block 180-b, where the bitmap 205-b may include a bit 210-e corresponding to the block 170-b die 160-a, a bit 210-f corresponding to the block 170-b of the die 160-b, a bit 210-g corresponding to the block 170-b of the die 160-c, and a bit 210-h corresponding to the block 170-b of the die 160-d. As such, the memory system 110 may utilize the bit 210-e to track read operations performed at the block 170-b of the die 160-a, while the memory system 110 may utilize the bit 210-g to track read operations at the block 170-b of the die 160-c.

As such, the memory system 110 may modify one or more bits 210 of a bitmap 205 based on (e.g., in direct response) to read accesses detected at the blocks 170 of the dies 160 of the memory system 110. For example, after performing a read operation at a page 175 of the block 170-a of the die 160-a, the memory system 110 may set the bit 210-a of the bitmap 205-a to a first value (e.g., setting the bit to ‘1’). In some implementations, the first value may be represented by a ‘0’ or a ‘1’. Similarly, the memory system 110 may set the bit 210-b of the bitmap 205-a to the first value based on (e.g., in response to) a read operation at a page 175 of the block 170-a of the die 160-b.

In some implementations, the memory system 110 may include a set of read counters (e.g., stored in local memory 120) each corresponding to a respective virtual block 180. The memory system 110 may determine to adjust (e.g., increment) a read counter of the set of read counters if one or more conditions are met. For example, if each bit 210 of a bitmap 205 is raised (e.g., if all bits 210 of the bitmap 205 have the first value), indicating that a read operation has been performed on a respective block 170 of each die 160 associated with the virtual block 180, the memory system 110 may determine to increment the read counter associated with the virtual block 180. Based on (e.g., in response to) adjusting (e.g., incrementing) the read counter associated with the reset each bit 210 of the bitmap 205 to ‘0’. As an illustrative example, after performing a read operation on the block 170-b die 160-a, the memory system 110 may set the bit 210-e of the bitmap 205-b to ‘1’. Accordingly, after determining that all bits 210 of the bitmap 205-b are set to ‘1’, indicating that a read operation has occurred at the block 170-b across each of the dies 160, the memory system 110 may adjust the read counter associated with the virtual block 180-b. Based on (e.g., in response to) to adjusting the read counter for the virtual block 180-b, the memory system 110 may reset the bitmap 205-b (e.g., set all bits 210 to ‘0’).

Additionally, or alternatively, the memory system 110 may determine to adjust the read counter associated with the virtual block 180 in response to multiple read accesses to the same block 170 of a die 160. For example, if a bit 210 is to be raised based on (e.g., in response to) a read operation and the bit 210 is already raised, indicating that a previous read operation has occurred at the block 170 of the die 160 associated with the bit 210, the memory system 110 may adjust (e.g., increment) the read counter associated with the virtual block 180 and clear all bits of the corresponding bitmap 205 (e.g., setting each bit to ‘0’). As an illustrative example, the memory system 110 may perform a read operation at the block 170-a of the die 160-b, and accordingly may determine that the bit 210-b already has a value of ‘1’, therefore indicating that the read operation is a second read operation at the block 170-b of the die 160-b. Accordingly, the memory system 110 may adjust (e.g., increment) the read counter associated with the virtual block 180-a and may clear the bits 210 of the bitmap 205-a. In some cases, based on (e.g., in response to) adjusting (e.g., incrementing) the read counter associated with the virtual block 180-a and resetting the bitmap 205-a according to multiple accesses to the block 170-a of the die 160-b, the memory system 110 reset the bit 210-b to ‘1’ to maintain a record of the last read event at the block 170-a of the die 160-b.

By maintaining the bitmaps 205 for each virtual block 180, the memory system 110 may effectively monitor the multiple read operations across the dies 160 of a virtual block 180, which may result in relatively fewer adjustments (e.g., increments) to the associated read counter, thus decreasing read access overestimation.

FIG. 2B shows an example of a system 201 that supports reducing read disturbance overestimation in accordance with examples as disclosed herein. Aspects of the system 201 may implement, or be implemented by, aspects of the system 100. In the following description, some operations may be performed by a local controller 135 of the memory device 130, however, it should be understood that the operations described in the context of FIG. 2B may be performed by the memory system controller 115 of the memory system 110.

The memory system 110 may include one or more dies 160, such as a die 160-e and a die 160-f. Each die 160 may include one or more planes 165. For example, the die 160-e may include a plane 165-e and a plane 165-f and the die 160-f may include a plane 165-g and a plane 165-h. As described herein, each plane 165 may include one or more blocks 170, where each block 170 may include one or more pages 175 (e.g., pages 0-N). For example, the plane 165-e may include a block 170-c and a block 170-d, the plane 165-f may include a block 170-c and a block 170-d, the plane 165-g may include a block 170-c and a block 170-d, and the plane 165-h may include a block 170-c and a block 170-d. In such examples, the blocks 170-c of each plane 165 may be associated with a same block index, while the blocks 170-d at each plane 165 may be associated with a same block index.

In some examples, the memory system 110 may include one or more virtual blocks 180, where each virtual block 180 may include blocks 170 from each plane 165 that have a same block index. For example, the memory system 110 may include a first virtual block 180 (not shown) that includes the blocks 170-c across each of the planes 165 due to each of the blocks 170-c having a same block index. Similarly, the memory system 110 may include a second virtual block 180 that includes the blocks 170-d across each of the planes 165 due to each of the blocks 170-d having a same block index.

According to the techniques described herein, the memory system 110 may maintain respective bitmaps 205 for each virtual block 180, where each bit 210 of the respective bitmaps 205 may correspond to a respective block 170 of a respective plane 165 of a respective die 160. In such examples, the memory system 110 may utilize each bit 210 of the bitmaps 205 to track read operations (e.g., read accesses) occurring at corresponding blocks 170 of the planes 165 within the associated dies 160. As an illustrative example, the memory system 110 may maintain a bitmap 205-c for the first virtual block 180, where the bitmap 205-c may include a bit 210-i corresponding to the block 170-c of the plane 165-e of the die 160-e, include a bit 210-j corresponding to the block 170-c of the plane 165-f of the die 160-e, include a bit 210-k corresponding to the block 170-c of the plane 165-g of the die 160-f, and include a bit 210-l corresponding to the block 170-c of the plane 165-h of the die 160-f. As such, the memory system 110 may utilize the bit 210-i to track read operations performed at the block 170-c of plane 165-e, while the memory system 110 may utilize the bit 210-j to track read operations at the block 170-c of plane 165-f.

Similarly, the memory system 110 may maintain a bitmap 205-d for the second virtual block 180, where the bitmap 205-d may include a bit 210-m corresponding to the block 170-d of the plane 165-e of the die 160-e, include a bit 210-n corresponding to the block 170-d of the plane 165-f of the die 160-e, include a bit 210-o corresponding to the block 170-d of the plane 165-g of the die 160-f, and include a bit 210-p corresponding to the block 170-d of the plane 165-h of the die 160-f. As such, the memory system 110 may utilize the bit 210-m to track read operations performed at the block 170-d of plane 165-e, while the memory system 110 may utilize the bit 210-n to track read operations at the block 170-d of plane 165-f.

Accordingly, the memory system 110 may modify one or more bits 210 of the bitmaps 205 based on (e.g., in direct response to) read accesses detected at the blocks 170 of the planes 165. For example, after performing a read operation at the block 170-c of the plane 165-e, the memory system 110 may set the bit 210-i of the bitmap 205-c to a first value (e.g., setting the bit to ‘1’). In some implementations, the first value may be represented by a ‘0’ or a ‘1’. Similarly, the memory system 110 may set the bit 210-j of the bitmap 205-c to the first value based on (e.g., in response to) a read operation at the block 170-c of the plane 165-f.

In some implementations, the memory system 110 may include a set of read counters (e.g., stored in local memory 120) each corresponding to a respective virtual block 180. The memory system 110 (e.g., via the memory system controller 115) may determine to adjust (e.g., increment) a read counter of the set of read counters if one or more conditions are met. For example, if each bit 210 of a bitmap 205 is raised (e.g., if all bits 210 of the bitmap 205 have the first value), indicating that a read operation has been performed on each block 170 from each plane 165 of each die 160, the memory system 110 may determine to adjust (e.g., increment) the read counter associated with the virtual block 180 that includes (e.g., is composed by) the block 170 taken from each plane 165 of each die 160. Based on (e.g., in response to) adjusting (e.g., incrementing) the read counter associated with the reset each bit 210 of the bitmap 205 to ‘0’. As an illustrative example, after performing a read operation on the block 170-c of the plane 165-e, the memory system 110 may set the bit 210-i of the bitmap 205-c to ‘1’. Accordingly, after determining that all bits 210 of the bitmap 205-c are set to ‘1’, indicating that the block 170-c of each plane 165 of the dies 160 have been read from, the memory system 110 may adjust the read counter associated with a first virtual block 180. Based on (e.g., in response to) adjusting the read counter for the first virtual block 180, the memory system 110 may reset the bitmap 205-c (e.g., set all bits 210 to ‘0’).

Additionally, or alternatively, the memory system 110 (e.g., via the memory system controller 115) may determine to adjust the read counter associated with the virtual block 180 based on (e.g., in response to) multiple read accesses to a block 170 of a plane 165. For example, if a bit 210 is to be raised based on (e.g., in response to) a read operation and the bit 210 is already raised, indicating that a previous read operation has occurred at the block 170 of the plane 165 associated with the bit 210, the memory system 110 may adjust (e.g., increment) the read counter associated with the virtual block 180 and clear all bits of the corresponding bitmap 205 (e.g., setting each bit to ‘0’).

As an illustrative example, the memory system 110 may perform a read operation at the block 170-c of the plane 165-f, and accordingly may determine that the bit 210-j already has a value of ‘1’, therefore indicating that the read operation is a second read operation at the block 170-c of the plane 165-f. Accordingly, the memory system 110 (e.g., via the memory system controller 115) may adjust (e.g., increment) the read counter associated with the first virtual block 180 and may clear the bits 210 of the bitmap 205-c. In some cases, based on (e.g., in response to) adjusting (e.g., incrementing) the read counter associated with the first virtual block 180 and resetting the bitmap 205-c based on multiple accesses to the block 170-c of the plane 165-f, the memory system 110 may reset the bit 210-b to ‘1’ to maintain a record of the last read event at the block 170-c of the plane 165-f.

In such examples, if the read counter associated with the virtual block 180 of the memory system 110 satisfies a threshold, the memory system 110 may trigger one or more refresh operations at the virtual block 180, where the refresh operations may be performed on each block 170 of each plane 165 of each die 160 that are associated with the virtual block 180 (e.g., involving all the dies and planes providing their own block to form the virtual block). As an illustrative example, if, based on (e.g., in response to) adjusting (e.g., incrementing) the read counter associated with the first virtual block 180 (e.g., associated with the bitmap 205-c), the read counter satisfies a threshold, the memory system 110 may perform a refresh operation at all the blocks 170-c of each plane 165 of each die 160, which may be related to the first virtual block 180 for which the threshold has been satisfied. By maintaining the bitmaps 205 for each virtual block 180, the memory system 110 may effectively monitor the multiple read operations across the blocks 170 of each plane 165, which may result in relatively fewer adjustments (e.g., increments) to the associated read counter, thus decreasing read access overestimation.

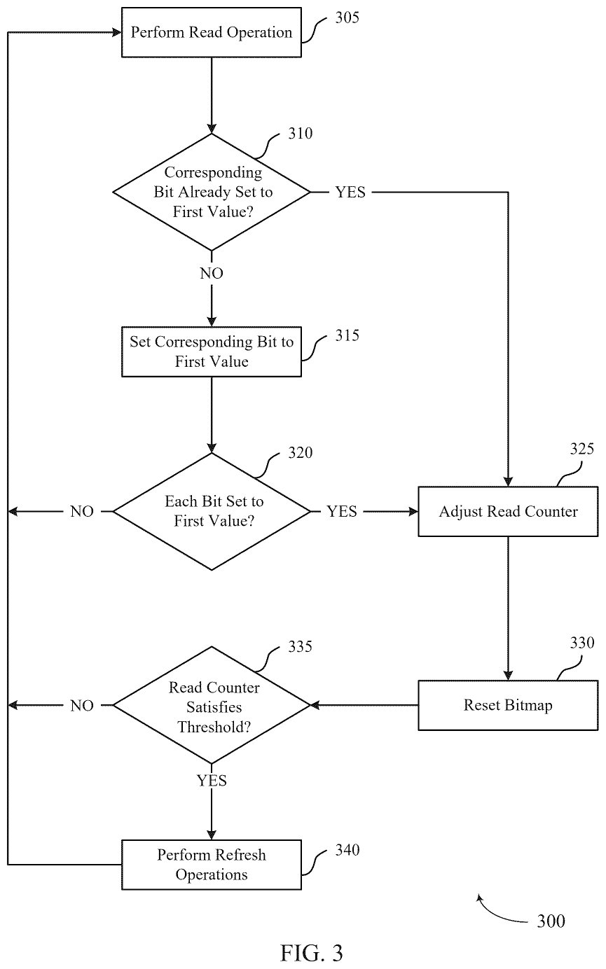

FIG. 3 shows an example of a process flow 300 that supports reducing read disturbance overestimation in accordance with examples as disclosed herein. The process flow 300 includes multiple steps or operations that may be performed by a memory system 110, a memory device 130, or both, as described herein with respect to FIGS. 1-2B. In the following description of the process flow 300, the steps or operations may be performed in a different order than the example order shown. Some operations may also be omitted from the process flow 300, and other operations may be added to the process flow 300. Further, although some operations or signaling may be shown to occur at different times for discussion purposes, these operations may actually occur at the same time.

Aspects of the process flow 300 may be implemented by one or more controllers, among other components. Additionally, or alternatively, aspects of the process flow 300 may be implemented as instructions stored in one or more memories (e.g., firmware stored in one or more memories coupled with one or more controllers). For example, the instructions, when executed by one or more controllers (e.g., the memory system controller 115 or a local controller 135-a), may cause the one or more controllers (or a device or a system) to perform the operations of the process flow 300. Further, although some procedures and operations in the process flow 300 are described in the context of FIG. 2A (e.g., where each bit of a bitmap corresponds to block 170 of a respective die 160), similar procedures and operations may be performed in the context of FIG. 2B (e.g., where each bit of a bitmap corresponds to a block 170 of a plane 165).

The techniques described in the context of the process flow 300 may enable the memory system 110 to maintain a respective bitmap (e.g., bitmap 205) for each virtual block 180 of the memory system 110, such that the memory system 110 may reduce a quantity of refresh operations performed at the dies 160 associated with the virtual block 180. That is, the memory system 110 may introduce, per virtual block 180, a volatile bitmap, where each bit of the bitmap represents whether a read access has occurred on a first block 170 of a respective die 160 associated with the virtual block 180. As described herein, the memory system 110 may store the bitmap in the local memory 120 of the memory system controller 115.

At 305, one or more read operations may be performed. In some examples, the memory system 110 may determine to perform one or more read operations as part of one or more internal operations. Alternatively, the memory system 110 may receive a command to perform the one or more read operations (e.g., from a host system 105). For example, the memory system 110 may perform a first read operation at a first block 170 of a first die 160 of a set of dies 160, where a respective first block 170 of each die 160 of the set of dies 160 may be associated with a first virtual block 180. That is, the first block 170 of each die 160 may be associated with (e.g., have) a same block index. Accordingly, each first block 170 of across the set of dies 160 may correspond to the first virtual block 180.

At 310, a first bit of a bitmap associated with the virtual block 180 may be determined. For example, based on (e.g., in response to) performing the first read operation at 305, the memory system 110 may determine whether the first bit corresponding to the first block 170 of the first die 160 has already been set to a first value (e.g., ‘1’), which may indicate that a read operation has already been performed on at the first block 170 of the first die 160. In such examples, if the first bit of the bitmap is already set to the first value, the memory system 110 may proceed to perform the operations at 325. Alternatively, if the first bit of the bitmap has not been set to the first value (e.g., is set to a ‘0’), the memory system 110 may proceed to perform the operations at 315.

At 315, the first bit may be set to the first value. For example, based on (e.g., in response to) performing the read operation at 305 on first block 170 of the first die 160, the memory system 110 may set the first bit to the first value. As an illustrative example, if the memory system 110 performs a read operation on the first block 170 of an nth die 160 of the virtual block 180, the memory system 110 may raise the nth bit of the bitmap (e.g., setting the nth bit to the first value). In some examples, the first value may be a ‘1’ and the second value may be a ‘0’, or vice versa.

At 320, values of each bit of the bitmap may be determined. For example, the memory system 110 may determine whether each bit of the bitmap associated with the virtual block 180 is set to the first value (e.g., a same value). Accordingly, if each (or every) bit of the bitmap is not set to the first value, indicating a read access has not been performed at the respective first blocks of each die 160 associated with the virtual block 180, the memory system 110 may proceed to the operations at 305 (e.g., waiting to perform another read operation at the first die 160 or performing one or more other read operations at other dies 160 of the virtual block 180). Alternatively, if each bit of the bitmap is set to the first value, indicating a read access has been performed on the respective first block across each die 160 associated with the virtual block 180, the memory system 110 may proceed to the operations at 325.

At 325, the read counter may be adjusted. For example, as described herein, the memory system 110 may adjust (e.g., increment) the read counter (e.g., a value of the read counter) associated with the virtual block 180. In such examples, the memory system 110 may adjust (e.g., increment) the read counter associated with the virtual block 180 if each bit of the associated bitmap is set to the first value or if the memory system 110 performs consecutive read operations at the first block 170 of the first die 160 of the virtual block 180.

At 330, the bitmap may be reset. For example, the memory system 110 may reset the bitmap based on (e.g., in response to) adjusting the read counter associated with the virtual block 180. In some cases, resetting the bitmap may include setting each bit of the bitmap to a second value (e.g., ‘0’). In some examples, the memory system 110 may reset the bitmap based on (e.g., in response to) (or concurrently with) adjusting the read counter at 325.

In some examples, if, at 310, it was determined that the first bit was set to the first value, indicating that two read operations have been performed at the first block 170 of the first die 160, the memory system 110 may set the first bit corresponding to the first block 170 of the first die 160 to the first value based on (e.g., in response to) resetting the bitmap. Alternatively, the memory system 110 may reset each bit of the bitmap, except for the first bit, to the second value (e.g., to a ‘0’). In this way, the memory system 110 may maintain a record of the most recent read operation at the first block 170 of the first die 160 in the bitmap.

At 335, a determination as to whether the read counter satisfies a threshold may be made. For example, the memory system 110 may determine whether the read counter (e.g., a value of the read counter) satisfies a threshold. For example, the threshold may be a quantity of read operations. If the read counter does not satisfy (e.g., meet or exceed) the threshold, the memory system 110 may proceed to the operations at 305.

At 340, one or more refresh operations may be performed. For example, if the read counter satisfies (e.g., meets or exceeds) the threshold, the memory system 110 may perform one or more refresh operations at the first blocks across each dies 160 associated with the virtual block 180. The one or more refresh operations may be a part of a read disturbance management procedure.

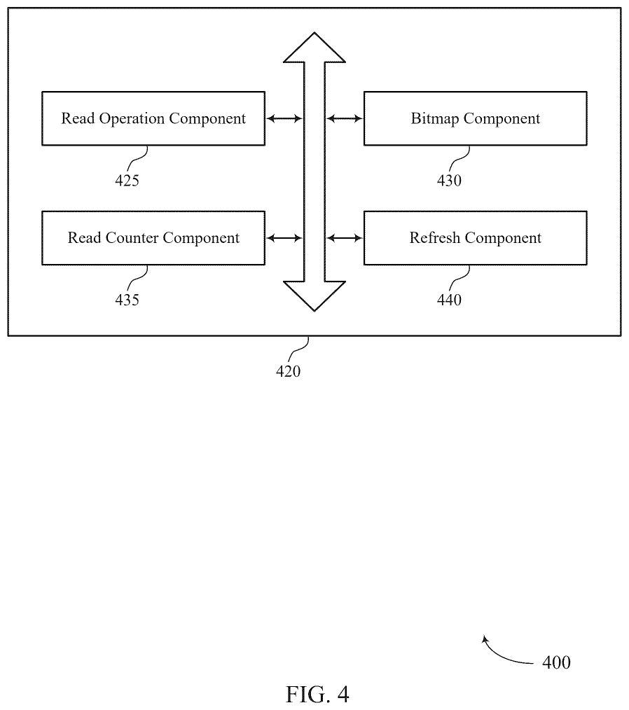

FIG. 4 shows a block diagram 400 of a memory system 420 that supports read disturbance overkill mitigation in accordance with examples as disclosed herein. The memory system 420 may be an example of aspects of a memory system as described with reference to FIGS. 1 through 3. The memory system 420, or various components thereof, may be an example of means for performing various aspects of read disturbance overkill mitigation as described herein. For example, the memory system 420 may include a read operation component 425, a bitmap component 430, a read counter component 435, a refresh component 440, or any combination thereof. Each of these components, or components of subcomponents thereof (e.g., one or more processors, one or more memories), may communicate, directly or indirectly, with one another (e.g., via one or more buses).

The memory system 420 may support operating a memory system in accordance with examples as disclosed herein. The read operation component 425 may be configured as or otherwise support a means for performing a first read operation at a first block of a first memory die of a set of memory dies, a respective block of each memory die of the set of memory dies being associated with a virtual block. The bitmap component 430 may be configured as or otherwise support a means for setting a first bit of a bitmap to a first value based at least in part on performing the first read operation, where the bitmap is associated with the virtual block and where the first bit of the bitmap corresponds to the first block of the first memory die. The read counter component 435 may be configured as or otherwise support a means for determining whether to adjust a read counter associated with the virtual block based at least in part on respective values of each bit of the bitmap.

In some examples, the read counter component 435 may be configured as or otherwise support a means for adjusting the read counter based at least in part on determining that each bit of the bitmap is set to the first value.

In some examples, the read operation component 425 may be configured as or otherwise support a means for performing, based at least in part on performing the first read operation, a second read operation at the first block of the first memory die. In some examples, the read counter component 435 may be configured as or otherwise support a means for adjusting the read counter based at least in part on determining that the first bit of the bitmap is set to the first value and on performing the second read operation at the first block of the first memory die.

In some examples, the bitmap component 430 may be configured as or otherwise support a means for resetting the bitmap based at least in part on determining to adjust the read counter associated with the virtual block.

In some examples, the read counter component 435 may be configured as or otherwise support a means for refraining from adjusting the read counter based at least in part on determining that each bit of the bitmap is not set to the first value.

In some examples, the refresh component 440 may be configured as or otherwise support a means for performing one or more refresh operations on the respective first blocks of each memory die of the set of memory dies based at least in part on the read counter satisfying a threshold.

In some examples, the read operation component 425 may be configured as or otherwise support a means for performing a second read operation at a second block of the first memory die, respective second blocks of each memory die of the set of memory dies being associated with a send virtual block. In some examples, the bitmap component 430 may be configured as or otherwise support a means for setting a first bit of a second bitmap to the first value based at least in part on performing the second read operation, where the second bitmap is associated with the second virtual block and the first bit of the second bitmap corresponds to the second block of the first memory die of the set of memory dies. In some examples, the read counter component 435 may be configured as or otherwise support a means for determining whether to adjust a second read counter associated with the second virtual block based at least in part on respective values of each bit of the second bitmap.

In some examples, the read counter component 435 may be configured as or otherwise support a means for adjusting the second read counter based at least in part on determining that each bit of the second bitmap is set to the first value.

In some examples, each bit of the bitmap corresponds to a respective first block of each memory die of the set of memory dies. In some examples, each respective first block of each memory die of the set of memory dies includes a same block index.

In some examples, the bitmap is stored in volatile memory of the memory system.

Additionally, or alternatively, the memory system 420 may support operating a memory system in accordance with examples as disclosed herein. In some examples, the read operation component 425 may be configured as or otherwise support a means for performing a first read operation at a first block of a first plane of a set of planes, where a respective first block of each plane of the set of planes is associated with a virtual block. In some examples, the bitmap component 430 may be configured as or otherwise support a means for setting a first bit of a bitmap to a first value based at least in part on performing the first read operation, where the bitmap is associated with the virtual block and where the first bit of the bitmap corresponds to the first block of the first plane of the set of planes. In some examples, the read counter component 435 may be configured as or otherwise support a means for determining whether to adjust a read counter associated with the virtual block based at least in part on respective values of each bit of the bitmap.

In some examples, the read counter component 435 may be configured as or otherwise support a means for adjusting the read counter based at least in part on determining that each bit of the bitmap is set to the first value.

In some examples, the read operation component 425 may be configured as or otherwise support a means for performing, based at least in part on performing the first read operation, a second read operation at the first block of the first plane. In some examples, the read counter component 435 may be configured as or otherwise support a means for adjusting the read counter based at least in part on determining that the first bit of the bitmap is set to the first value and on performing the second read operation at the first block of the first plane.

In some examples, the bitmap component 430 may be configured as or otherwise support a means for resetting the bitmap based at least in part on determining to adjust the read counter associated with the virtual block.

In some examples, the read counter component 435 may be configured as or otherwise support a means for refraining from adjusting the read counter based at least in part on determining that at each bit of the bitmap is set not to the first value.

In some examples, the refresh component 440 may be configured as or otherwise support a means for performing one or more refresh operations on the respective first blocks of each plane of the set of planes based at least in part on the read counter satisfying a threshold.

In some examples, the read operation component 425 may be configured as or otherwise support a means for performing a second read operation at a second block of the first plane, where respective second blocks of each plane of the set of planes are associated with a second virtual block. In some examples, the bitmap component 430 may be configured as or otherwise support a means for setting a first bit of a second bitmap to the first value based at least in part on performing the second read operation, where the second bitmap is associated with the second virtual block and the first bit of the second bitmap corresponds to the second block of the first plane. In some examples, the read counter component 435 may be configured as or otherwise support a means for determining whether to adjust a second read counter associated with the second virtual block based at least in part on respective values of each bit of the second bitmap.

In some examples, the read counter component 435 may be configured as or otherwise support a means for adjusting the second read counter based at least in part on determining that each bit of the second bitmap is set to the first value.

In some examples, each bit of the bitmap corresponds to a respective first block of each plane of the set of planes. In some examples, each respective first block of each plane of the set of planes includes a same block index.

In some examples, the bitmap is stored in volatile memory of the memory system.

In some examples, each plane of the set of planes are included in a memory die, a first subset of the set of planes are included in first memory die and a second subset of the set of planes are included in a second memory die, or each plane of the set of planes are included in a respective memory die of the memory system.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

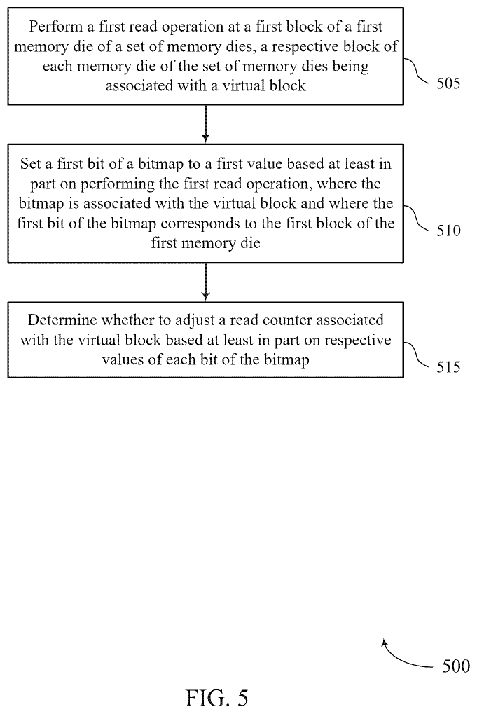

FIG. 5 shows a flowchart illustrating a process 500 that supports read disturbance overkill mitigation in accordance with examples as disclosed herein. The operations of process 500 may be implemented by a memory system or its components as described herein. For example, the operations of process 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the process may include performing a first read operation at a first block of a first memory die of a set of memory dies, a respective block of each memory die of the set of memory dies being associated with a virtual block. In some examples, aspects of the operations of 505 may be performed by a read operation component 425 as described with reference to FIG. 4.

At 510, the process may include setting a first bit of a bitmap to a first value based at least in part on performing the first read operation, where the bitmap is associated with the virtual block and where the first bit of the bitmap corresponds to the first block of the first memory die. In some examples, aspects of the operations of 510 may be performed by a bitmap component 430 as described with reference to FIG. 4.

At 515, the process may include determining whether to adjust a read counter associated with the virtual block based at least in part on respective values of each bit of the bitmap. In some examples, aspects of the operations of 515 may be performed by a read counter component 435 as described with reference to FIG. 4.

In some examples, an apparatus as described herein may perform a process or processes, such as the process 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for performing a first read operation at a first block of a first memory die of a set of memory dies, a respective block of each memory die of the set of memory dies being associated with a virtual block; setting a first bit of a bitmap to a first value based at least in part on performing the first read operation, where the bitmap is associated with the virtual block and where the first bit of the bitmap corresponds to the first block of the first memory die; and determining whether to adjust a read counter associated with the virtual block based at least in part on respective values of each bit of the bitmap.

Aspect 2: The method, apparatus, or non-transitory computer-readable medium of aspect 1, further including operations, features, circuitry, logic, means, or instructions, or any combination thereof for adjusting the read counter based at least in part on determining that each bit of the bitmap is set to the first value.

Aspect 3: The method, apparatus, or non-transitory computer-readable medium of any of aspects 1 through 2, further including operations, features, circuitry, logic, means, or instructions, or any combination thereof for performing, based at least in part on performing the first read operation, a second read operation at the first block of the first memory die and adjusting the read counter based at least in part on determining that the first bit of the bitmap is set to the first value and on performing the second read operation at the first block of the first memory die.

Aspect 4: The method, apparatus, or non-transitory computer-readable medium of any of aspects 1 through 3, further including operations, features, circuitry, logic, means, or instructions, or any combination thereof for resetting the bitmap based at least in part on determining to adjust the read counter associated with the virtual block.

Aspect 5: The method, apparatus, or non-transitory computer-readable medium of any of aspects 1 through 4, further including operations, features, circuitry, logic, means, or instructions, or any combination thereof for refraining from adjusting the read counter based at least in part on determining that each bit of the bitmap is not set to the first value.

Aspect 6: The method, apparatus, or non-transitory computer-readable medium of any of aspects 1 through 5, further including operations, features, circuitry, logic, means, or instructions, or any combination thereof for performing one or more refresh operations on the respective first blocks of each memory die of the set of memory dies based at least in part on the read counter satisfying a threshold.

Aspect 7: The method, apparatus, or non-transitory computer-readable medium of any of aspects 1 through 6, further including operations, features, circuitry, logic, means, or instructions, or any combination thereof for performing a second read operation at a second block of the first memory die, respective second blocks of each memory die of the set of memory dies being associated with a send virtual block; setting a first bit of a second bitmap to the first value based at least in part on performing the second read operation, where the second bitmap is associated with the second virtual block and the first bit of the second bitmap corresponds to the second block of the first memory die of the set of memory dies; and determining whether to adjust a second read counter associated with the second virtual block based at least in part on respective values of each bit of the second bitmap.

Aspect 8: The method, apparatus, or non-transitory computer-readable medium of aspect 7, further including operations, features, circuitry, logic, means, or instructions, or any combination thereof for adjusting the second read counter based at least in part on determining that each bit of the second bitmap is set to the first value.

Aspect 9: The method, apparatus, or non-transitory computer-readable medium of any of aspects 1 through 8, where each bit of the bitmap corresponds to a respective first block of each memory die of the set of memory dies and each respective first block of each memory die of the set of memory dies includes a same block index.

Aspect 10: The method, apparatus, or non-transitory computer-readable medium of any of aspects 1 through 9, where the bitmap is stored in volatile memory of the memory system.

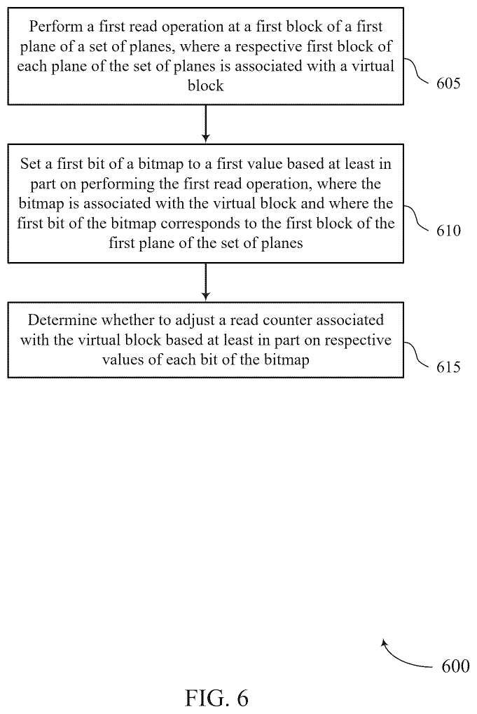

FIG. 6 shows a flowchart illustrating a process 600 that supports read disturbance overkill mitigation in accordance with examples as disclosed herein. The operations of process 600 may be implemented by a memory system or its components as described herein. For example, the operations of process 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the process may include performing a first read operation at a first block of a first plane of a set of planes, where a respective first block of each plane of the set of planes is associated with a virtual block. In some examples, aspects of the operations of 605 may be performed by a read operation component 425 as described with reference to FIG. 4.

At 610, the process may include setting a first bit of a bitmap to a first value based at least in part on performing the first read operation, where the bitmap is associated with the virtual block and where the first bit of the bitmap corresponds to the first block of the first plane of the set of planes. In some examples, aspects of the operations of 610 may be performed by a bitmap component 430 as described with reference to FIG. 4.

At 615, the process may include determining whether to adjust a read counter associated with the virtual block based at least in part on respective values of each bit of the bitmap. In some examples, aspects of the operations of 615 may be performed by a read counter component 435 as described with reference to FIG. 4.

In some examples, an apparatus as described herein may perform a process or processes, such as the process 600. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for performing a first read operation at a first block of a first plane of a set of planes, where a respective first block of each plane of the set of planes is associated with a virtual block; setting a first bit of a bitmap to a first value based at least in part on performing the first read operation, where the bitmap is associated with the virtual block and where the first bit of the bitmap corresponds to the first block of the first plane of the set of planes; and determining whether to adjust a read counter associated with the virtual block based at least in part on respective values of each bit of the bitmap.

Aspect 12: The method, apparatus, or non-transitory computer-readable medium of aspect 11, further including operations, features, circuitry, logic, means, or instructions, or any combination thereof for adjusting the read counter based at least in part on determining that each bit of the bitmap is set to the first value.

Aspect 13: The method, apparatus, or non-transitory computer-readable medium of any of aspects 11 through 12, further including operations, features, circuitry, logic, means, or instructions, or any combination thereof for performing, based at least in part on performing the first read operation, a second read operation at the first block of the first plane and adjusting the read counter based at least in part on determining that the first bit of the bitmap is set to the first value and on performing the second read operation at the first block of the first plane.

Aspect 14: The method, apparatus, or non-transitory computer-readable medium of any of aspects 11 through 13, further including operations, features, circuitry, logic, means, or instructions, or any combination thereof for resetting the bitmap based at least in part on determining to adjust the read counter associated with the virtual block.

Aspect 15: The method, apparatus, or non-transitory computer-readable medium of any of aspects 11 through 14, further including operations, features, circuitry, logic, means, or instructions, or any combination thereof for refraining from adjusting the read counter based at least in part on determining that at each bit of the bitmap is set not to the first value.

Aspect 16: The method, apparatus, or non-transitory computer-readable medium of any of aspects 11 through 15, further including operations, features, circuitry, logic, means, or instructions, or any combination thereof for performing one or more refresh operations on the respective first blocks of each plane of the set of planes based at least in part on the read counter satisfying a threshold.

Aspect 17: The method, apparatus, or non-transitory computer-readable medium of any of aspects 11 through 16, further including operations, features, circuitry, logic, means, or instructions, or any combination thereof for performing a second read operation at a second block of the first plane, where respective second blocks of each plane of the set of planes are associated with a second virtual block; setting a first bit of a second bitmap to the first value based at least in part on performing the second read operation, where the second bitmap is associated with the second virtual block and the first bit of the second bitmap corresponds to the second block of the first plane; and determining whether to adjust a second read counter associated with the second virtual block based at least in part on respective values of each bit of the second bitmap.

Aspect 18: The method, apparatus, or non-transitory computer-readable medium of aspect 17, further including operations, features, circuitry, logic, means, or instructions, or any combination thereof for adjusting the second read counter based at least in part on determining that each bit of the second bitmap is set to the first value.

Aspect 19: The method, apparatus, or non-transitory computer-readable medium of any of aspects 11 through 18, where each bit of the bitmap corresponds to a respective first block of each plane of the set of planes and each respective first block of each plane of the set of planes includes a same block index.

Aspect 20: The method, apparatus, or non-transitory computer-readable medium of any of aspects 11 through 19, where the bitmap is stored in volatile memory of the memory system.

Aspect 21: The method, apparatus, or non-transitory computer-readable medium of any of aspects 11 through 20, where each plane of the set of planes are included in a memory die, a first subset of the set of planes are included in first memory die and a second subset of the set of planes are included in a second memory die, or each plane of the set of planes are included in a respective memory die of the memory system.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
perform a first read operation at a first block of a first memory die of a set of memory dies, a respective first block of each memory die of the set of memory dies being associated with a virtual block;
set a first bit of a bitmap to a first value in response to performing the first read operation, wherein the bitmap is associated with the virtual block and wherein the first bit of the bitmap corresponds to the first block of the first memory die; and
determine whether to adjust a read counter associated with the virtual block in accordance with respective values of each bit of the bitmap.

2. The memory system of claim 1, wherein the processing circuitry is further configured to cause the memory system to:
adjust the read counter in response to determining that each bit of the bitmap is set to the first value.

3. The memory system of claim 1, wherein the processing circuitry is further configured to cause the memory system to:
perform, in response to performing the first read operation, a second read operation at the first block of the first memory die; and
adjust the read counter in response to determining that the first bit of the bitmap is set to the first value and on performing the second read operation at the first block of the first memory die.

4. The memory system of claim 1, wherein the processing circuitry is further configured to cause the memory system to:
reset the bitmap in response to determining to adjust the read counter associated with the virtual block.

5. The memory system of claim 1, wherein the processing circuitry is further configured to cause the memory system to:
refrain from adjusting the read counter in response to determining that each bit of the bitmap is not set to the first value.

6. The memory system of claim 1, wherein the processing circuitry is further configured to cause the memory system to:
perform one or more refresh operations on the respective first blocks of each memory die of the set of memory dies in response to the read counter satisfying a threshold.

7. The memory system of claim 1, wherein the processing circuitry is further configured to cause the memory system to:
perform a second read operation at a second block of the first memory die of the set of memory dies, a respective second block of each memory die of the set of memory dies being associated with a second virtual block;
set a first bit of a second bitmap to the first value in response to performing the second read operation, wherein the second bitmap is associated with the second virtual block and the first bit of the second bitmap corresponds to the second block of the first memory die of the set of memory dies; and
determine whether to adjust a second read counter associated with the second virtual block in accordance with respective values of each bit of the second bitmap.

8. The memory system of claim 7, wherein the processing circuitry is further configured to cause the memory system to:
adjust the second read counter in response to determining that each bit of the second bitmap is set to the first value.

9. The memory system of claim 1, wherein each bit of the bitmap corresponds to a respective first block of each memory die of the set of memory dies, and wherein each respective first block of each memory die of the set of memory dies comprises a same block index.

10. The memory system of claim 1, wherein the bitmap is stored in volatile memory of the memory system.

11. A memory system, comprising:
one or more memory devices; and
processing circuitry coupled with the one or more memory devices and configured to cause the memory system to:
perform a first read operation at a first block of a first plane of a set of planes, wherein a respective first block of each plane of the set of planes is associated with a virtual block;
set a first bit of a bitmap to a first value in response to performing the first read operation, wherein the bitmap is associated with the virtual block and wherein the first bit of the bitmap corresponds to the first block of the first plane of the set of planes; and
determine whether to adjust a read counter associated with the virtual block in accordance with respective values of each bit of the bitmap.

12. The memory system of claim 11, wherein the processing circuitry is further configured to cause the memory system to:
adjust the read counter in response to determining that each bit of the bitmap is set to the first value.

13. The memory system of claim 11, wherein the processing circuitry is further configured to cause the memory system to:
perform, in response to performing the first read operation, a second read operation at the first block of the first plane; and
adjust the read counter in response to determining that the first bit of the bitmap is set to the first value and on performing the second read operation at the first block of the first plane.

14. The memory system of claim 11, wherein the processing circuitry is further configured to cause the memory system to:
reset the bitmap in response to determining to adjust the read counter associated with the virtual block.

15. The memory system of claim 11, wherein the processing circuitry is further configured to cause the memory system to:
refrain from adjusting the read counter in accordance with determining that at each bit of the bitmap is set not to the first value.

16. The memory system of claim 11, wherein the processing circuitry is further configured to cause the memory system to:
perform one or more refresh operations on the respective first blocks of each plane of the set of planes in response to the read counter satisfying a threshold.

17. The memory system of claim 11, wherein the processing circuitry is further configured to cause the memory system to:
perform a second read operation at a second block of the first plane, wherein respective second blocks of each plane of the set of planes are associated with a second virtual block;
set a first bit of a second bitmap to the first value in response to performing the second read operation, wherein the second bitmap is associated with the second virtual block and the first bit of the second bitmap corresponds to the second block of the first plane; and
determine whether to adjust a second read counter associated with the second virtual block in accordance with respective values of each bit of the second bitmap.

18. The memory system of claim 17, wherein the processing circuitry is further configured to cause the memory system to:
adjust the second read counter in response to determining that each bit of the second bitmap is set to the first value.

19. The memory system of claim 11, wherein each bit of the bitmap corresponds to a respective first block of each plane of the set of planes, and wherein each respective first block of each plane of the set of planes comprises a same block index.

20. The memory system of claim 11, wherein:
each plane of the set of planes are included in a memory die,
a first subset of the set of planes are included in a first memory die and a second subset of the set of planes are included in a second memory die, or
each plane of the set of planes are included in a respective memory die of the memory system.

21. A non-transitory computer-readable medium storing code comprising instructions which, when executed by one or more processors of a memory system cause the memory system to:
perform a first read operation at a first block of a first memory die of a set of memory dies, a respective first block of each memory die of the set of memory dies being associated with a virtual block;
set a first bit of a bitmap to a first value in response to performing the first read operation, wherein the bitmap is associated with the virtual block and wherein the first bit of the bitmap corresponds to the first block of the first memory die; and
determine whether to adjust a read counter associated with the virtual block in accordance with respective values of each bit of the bitmap.

22. The non-transitory computer-readable medium of claim 21, wherein the instructions, when executed by the one or more processors of the memory system, further cause the memory system to:
adjust the read counter in response to determining that each bit of the bitmap is set to the first value.
